(19) United States
(12) Patent Application Publication
(10) Pub. No.: US 2012/0002858 A1
(43) Pub. Date: Jan. 5, 2012

(54) MOTION DETECTION AND CORRECTION IN MAGNETIC RESONANCE IMAGING FOR RIGID, NONRIGID, TRANSLATIONAL, ROTATIONAL, AND THROUGH-PLANE MOTION

(75) Inventors: Feng Huang, Gainesville, FL (US); Wei Lin, Gainesville, FL (US)

(73) Assignee: KONINKLIJKE PHILIPS ELECTRONICS N.V., EINDHOVEN (NL)

(21) Appl. No.: 13/254,467

(22) PCT Filed: Feb. 9, 2010
(86) PCT No.: PCT/IB2010/050591

§ 371 Date: Sep. 2, 2011

Related U.S. Application Data
(60) Provisional application No. 61/163,247, filed on Mar. 25, 2009.
(60) Provisional application No. 61/248,977, filed on Oct. 6, 2009.

(51) Int. Cl. G06K 9/00

(52) U.S. Cl. 382/131

(57) ABSTRACT

A magnetic resonance (MR) image reconstruction method comprises: compensating an MR imaging data set (36) for rigid subject motion based on comparison of reference k-space data (32) with region k-space data (34) acquired together with the MR imaging data set to generate an MR imaging data set (52) with rigid motion compensation; compensating the MR imaging data set (52) with rigid motion compensation for non-rigid subject motion by convolution with a kernel (82) embodying the at least one consistent correlation of k-space data of the MR imaging data set; and reconstructing the MR imaging data set with the compensation for rigid and non-rigid motion to generate a reconstructed subject image.

The following relates to the medical arts, magnetic resonance arts, and related arts.

Magnetic resonance (MR) imaging is a relatively slow process which can take anywhere between a few seconds to tens of minutes or longer. Because of this, image degradation or artifacts due to subject motion is a concern. Subject motion can be variously characterized. The motion can be translational or rotational. The motion can be rigid or non-rigid. For an acquired two-dimensional MR image, the motion can be further classified as in-plane motion or through-plane motion.

One way to counter such motion artifacts is to speed up the MR data acquisition in the hope that the data can be fully acquired before problematic subject motion occurs. This is a motivation behind partially parallel imaging (PPI) techniques such as SENSE. In PPI, a plurality of radio frequency coils acquire imaging data simultaneously using independent channels. Since the different coils have different coil sensitivities, which can be separately determined, the simultaneously acquired imaging data can be used to approximate the missing data. For example, in SENSE some phase encoding lines of k-space are not acquired, and the additional imaging data acquired using the plural coils together with the coil sensitivities are used to estimate the missing phase encoding lines. Such PPI techniques are useful, but may provide insufficient imaging data acquisition acceleration to avoid problematic subject motion. Moreover, it is known that the signal-to-noise ratio (SNR) degrades with coil geometry factor (g-factor).

Other approaches attempt to detect and compensate for subject motion. Existing techniques are relatively effective at detecting and compensating for rigid in-plane translational motion, which manifests as a phase shift in the k-space data. However, existing techniques are less effective or wholly ineffective at detecting and compensating for rotational motion, non-rigid motion, or through-plane motion. The limited scope of motion which can be detected and compensated using existing techniques substantially limits the effectiveness of detect-and-compensate motion suppression.

The following provides new and improved apparatuses and methods which overcome the above-referenced problems and others.

In accordance with one disclosed aspect, a method comprises detecting subject rotation in a magnetic resonance (MR) imaging data set and reconstructing the MR imaging data set compensating for the detected subject rotation to generate a reconstructed subject image.

In accordance with another disclosed aspect, a method comprises compensating an MR imaging data set for subject motion based on at least one consistent correlation of k-space data of the MR imaging data set and reconstructing the MR imaging data set to generate a reconstructed subject image.

In accordance with another disclosed aspect, a magnetic resonance imaging system comprises: a magnetic resonance (MR) scanner; and an image reconstruction module configured to reconstruct an MR imaging data set acquired by the MR scanner using a method as set forth in one or both of the two immediately preceding paragraphs. In accordance with another disclosed aspect, a digital storage medium stores instructions executable by a digital processor to reconstruct an MR imaging data set using a method as set forth in one or both of the two immediately preceding paragraphs. In accordance with another disclosed aspect, a processor is configured to reconstruct a MR imaging data set using a method as set forth in one or both of the two immediately preceding paragraphs.

One advantage resides in providing enhanced detection and compensation for rotational motion.

Another advantage resides in providing enhanced detection and compensation for through-plane motion.

Another advantage resides in providing enhanced detection and compensation for non-rigid motion.

Further advantages will be appreciated to those of ordinary skill in the art upon reading and understand the following detailed description.

The drawings are only for purposes of illustrating the preferred embodiments, and are not to be construed as limiting the invention.

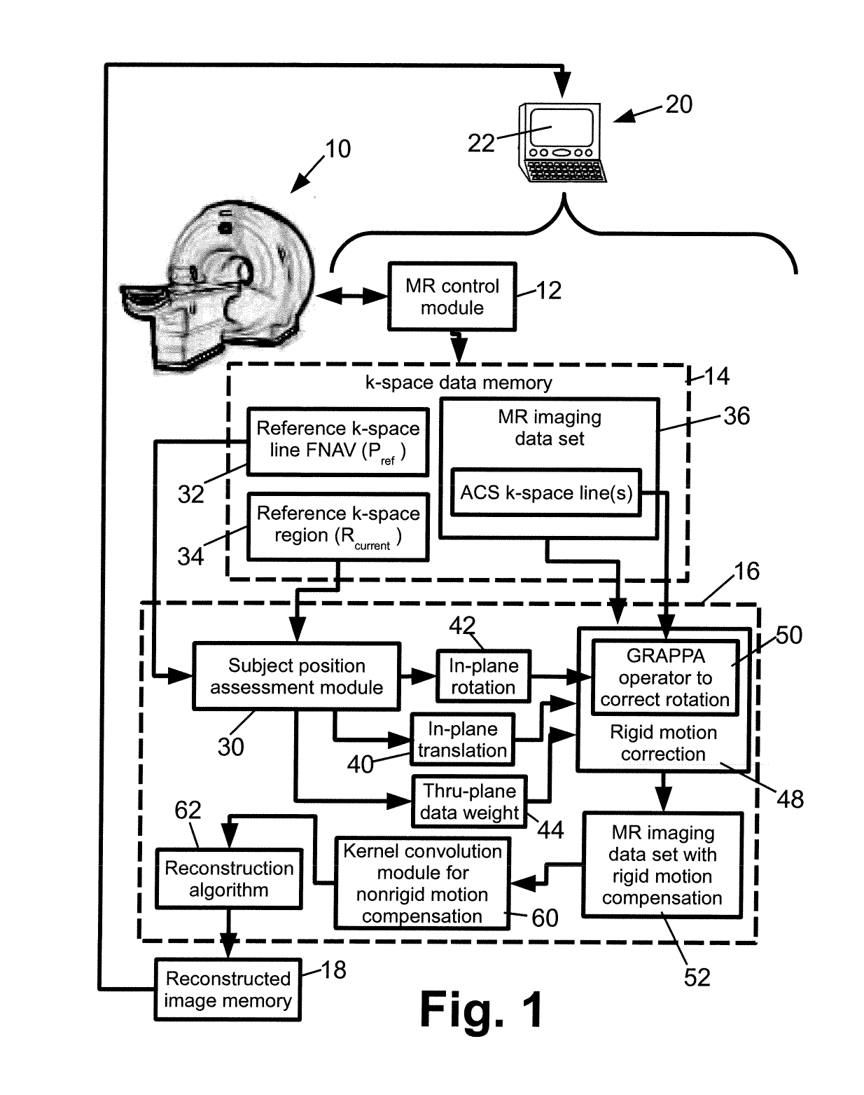

FIG. 1 diagrammatically shows an imaging system configured to perform magnetic resonance imaging including motion compensation as disclosed herein.

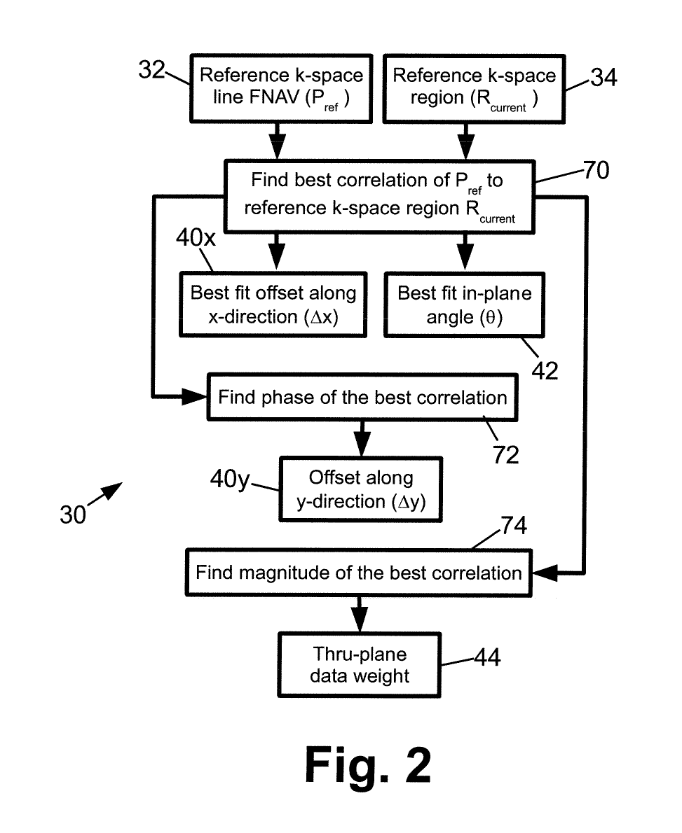

FIG. 2 diagrammatically shows a method suitably performed by the subject position assessment module of the imaging system of FIG. 1.

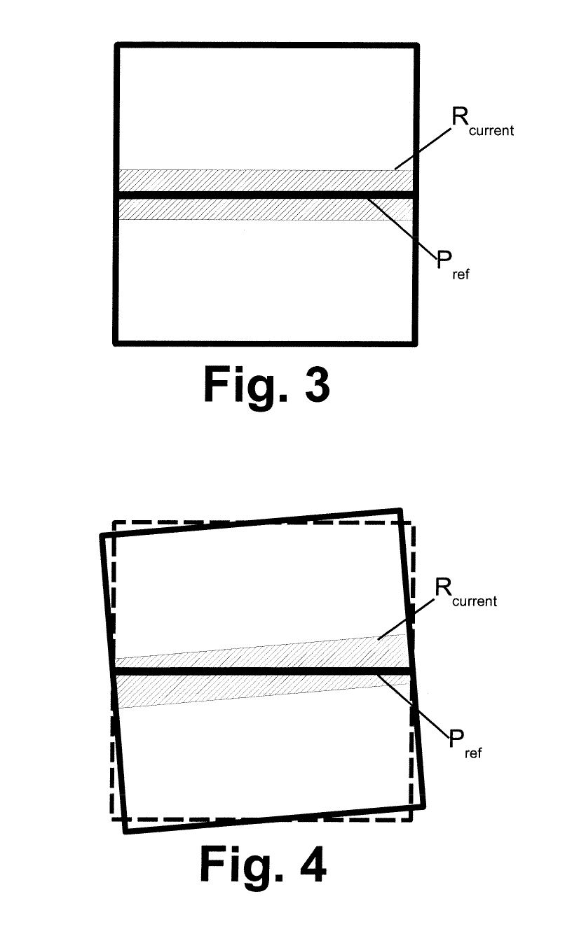

FIGS. 3 and 4 diagrammatically show subject rotation assessment suitably performed by the method of FIG. 2.

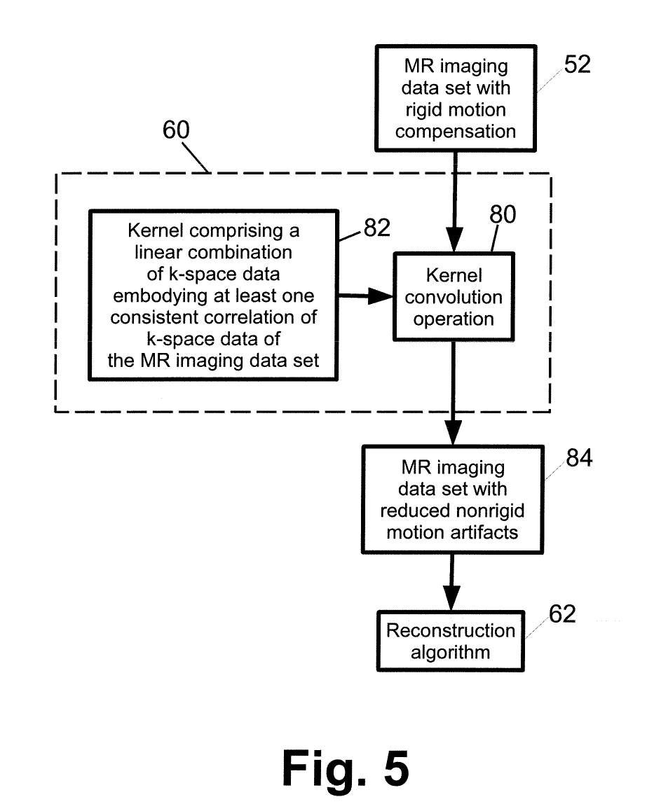

FIG. 5 diagrammatically shows a method suitably performed by the kernel convolution nonrigid motion compensation module of the imaging system of FIG. 1.

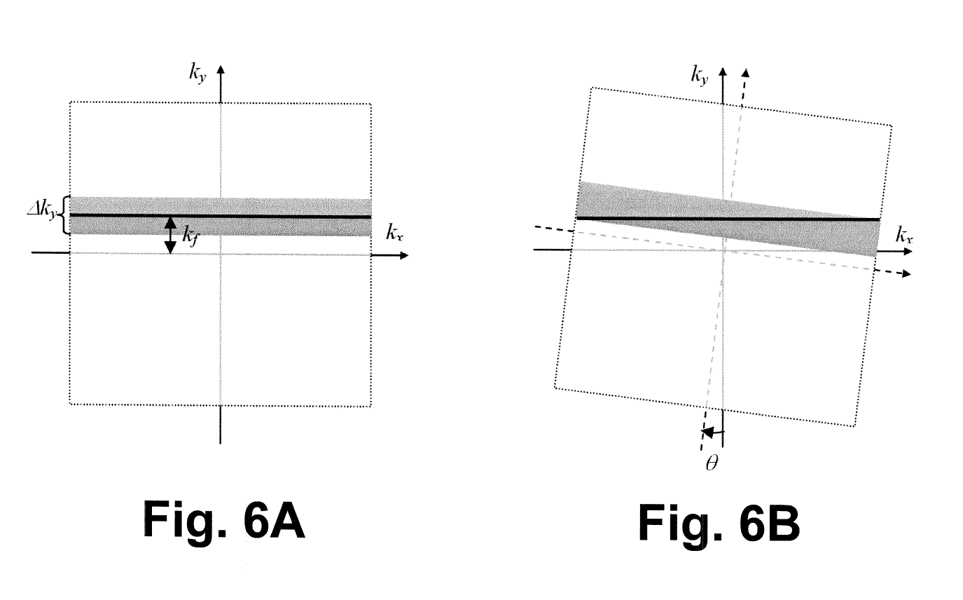

FIGS. 6A and 6B diagrammatically show the disclosed enhanced FNAV method. FIG. 6A shows the signal along a phase encoding line k_{y}=k_{f}≠0 which is repetitively acquired during the scan. In addition, a reference region centering around the FNAV line position is also acquired at the beginning of the scan. FIG. 6B diagrammatically shows detection of rotation, in which the reference data is rotated to various angles, prior to the computation of a correlation measure.

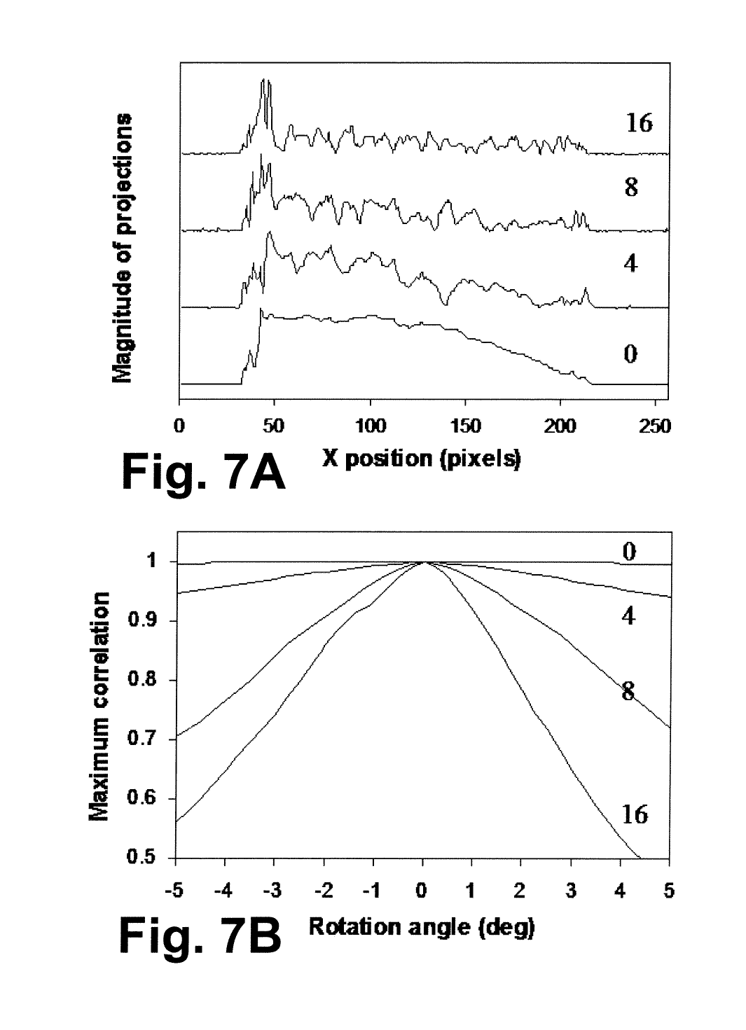

FIGS. 7A and 7B illustrate the effect of FNAV line position (k_{f}) on the accuracy of rotational motion detection with a brain dataset. FIG. 7A shows the generalized projection of FNAV line at different k_{f} values. FIG. 7B shows the profile of maximum correlation vs. rotation angles, for FNAV line at different k_{f} positions.

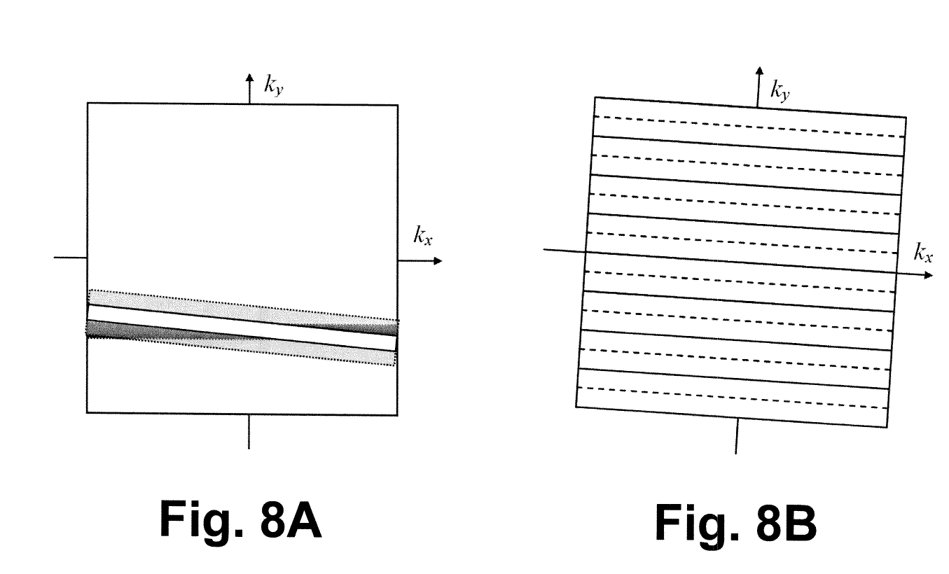

FIGS. 8A and 8B diagrammatically illustrate two disclosed methods to correct for motion-corrupted data with GRAPPA operators. In FIG. 8A, GRAPPA extrapolation operators generate missing “pie-slice” of k-space (darkest regions) due to rotation. In FIG. 8B, GRAPPA interpolation operators generate k-space (dashed) lines from an interleaved dataset, prior to the application of subsequent correction.

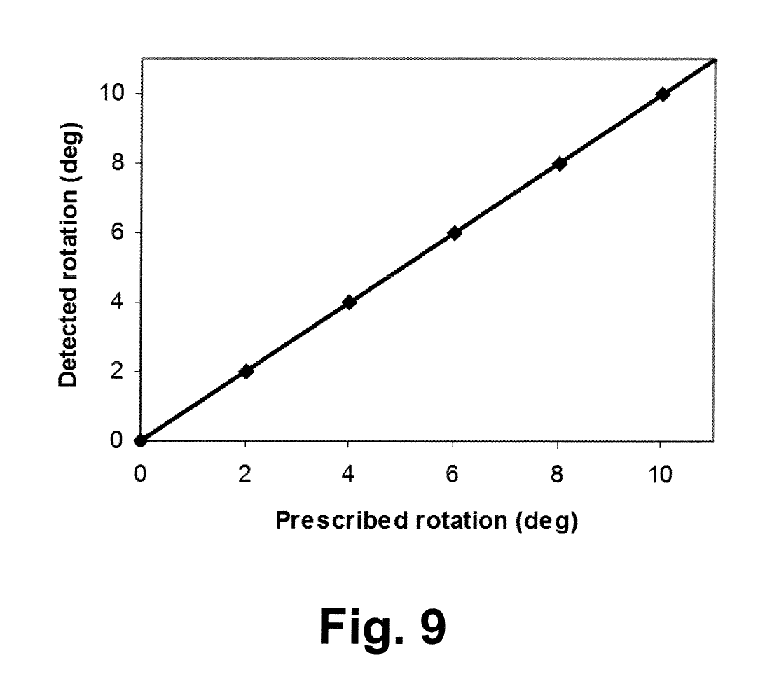

FIG. 9 shows a comparison of rotation detected from FNAV data and the gold standard in a phantom experiment.

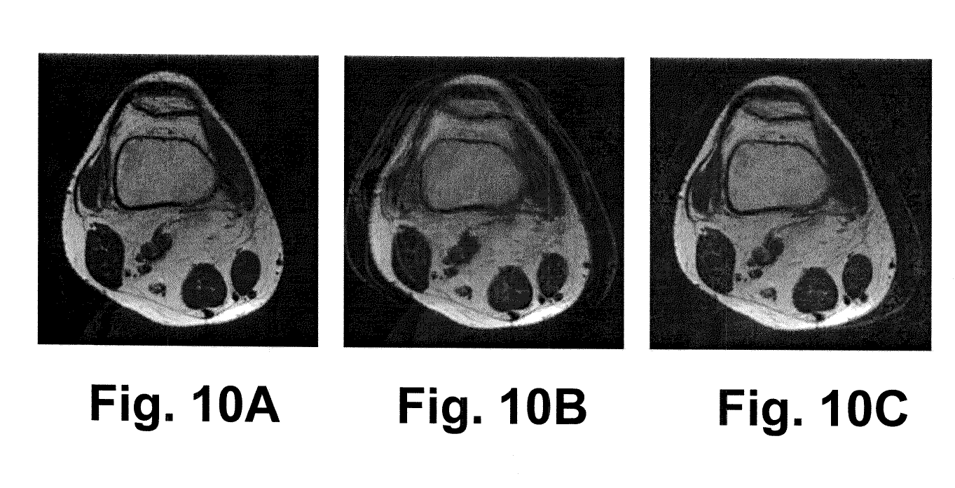

FIGS. 10A, 10B, and 10C show images from a knee imaging experiment, with an 8-channel coil. Data were acquired with a linear phase-encoding order. FIG. 10A shows a motion-free image. FIG. 10B shows a motion-corrupted image. FIG. 10C shows a motion-corrected image employing the disclosed motion correction methodology.

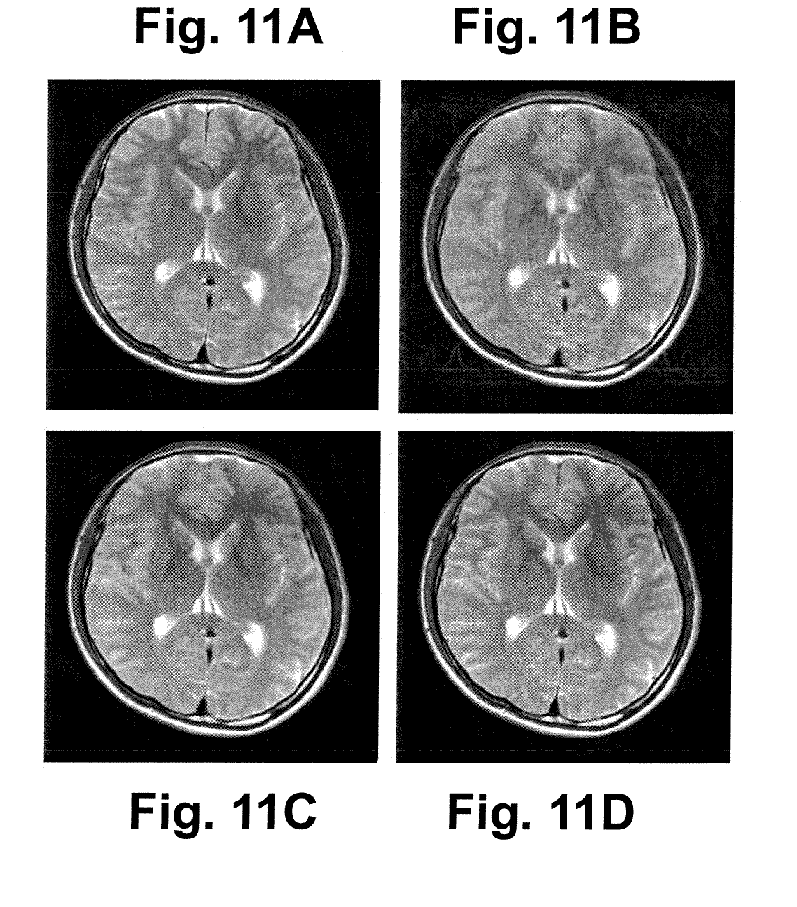

FIGS. 11A, 11B, 11C, and 11D show images from a brain imaging experiment, with an 8-channel coil. Data were acquired with an interleave factor of 4. FIG. 11A shows a motion-free image. FIG. 11B shows a motion-corrupted image. FIGS. 11C and 11D show motion-corrected images with the disclosed motion correction methodology, without (FIG. 11C) and with (FIG. 11D) rejection of interleaves with strong intra-leaf rotation.

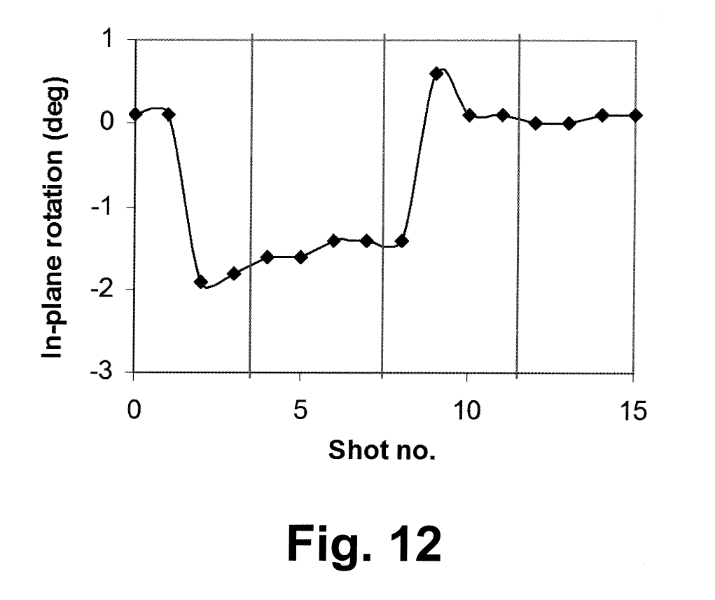

FIG. 12 shows in-plane rotation detected from FNAV during the imaging of FIGS. 11A-11D, with different interleaves separated by vertical lines.

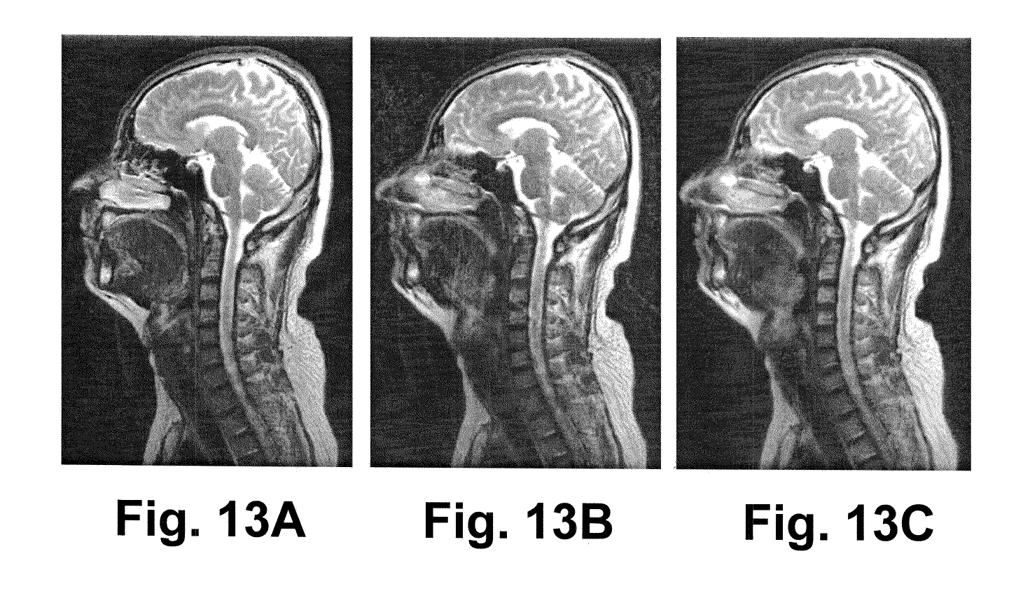

FIGS. 13A, 13B, and 13C show images from a spine imaging experiment, with an 16-channel coil. Data were acquire with an interleave factor of 4. FIG. 13A shows a motion-free image. FIG. 13B shows a motion-corrupted image. FIG. 13C shows a motion-corrected image employing the disclosed motion correction methodology.

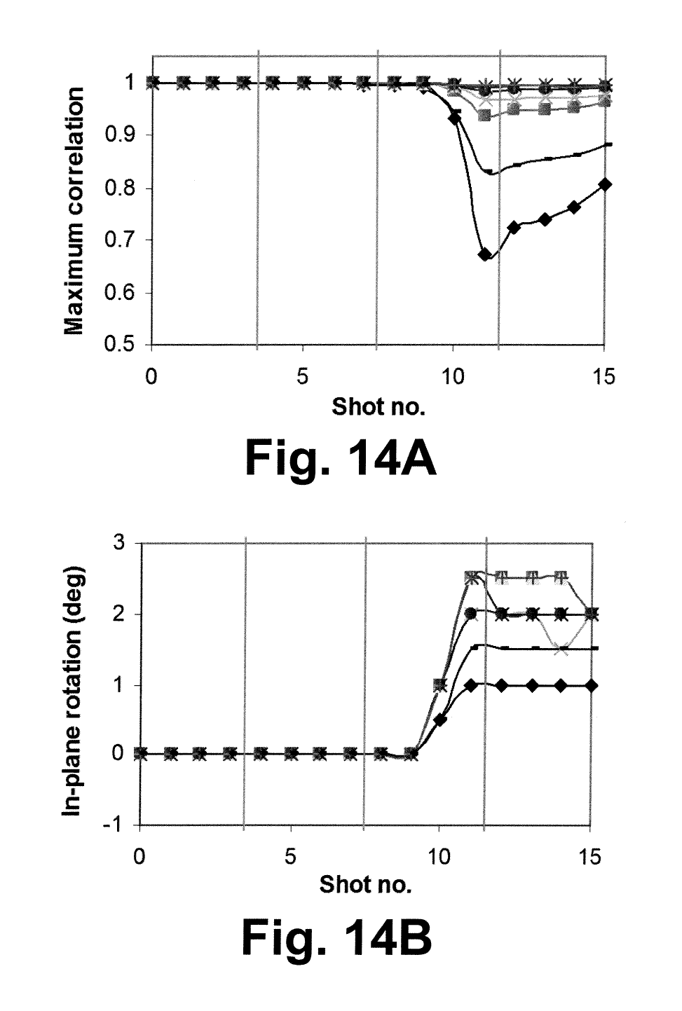

FIGS. 14A and 14B show correction of through-plane motion with high-pass GRPPA demonstrated in a phantom imaging experiment. Data were acquire with an interleave factor of 4 and an 8-channel coil. FIG. 14A shows maximum correlation detected from FNAV signals, with different curves indicates corresponding to different coils. Different interleaves were separated by vertical lines. FIG. 14B shows detected in-plane rotation.

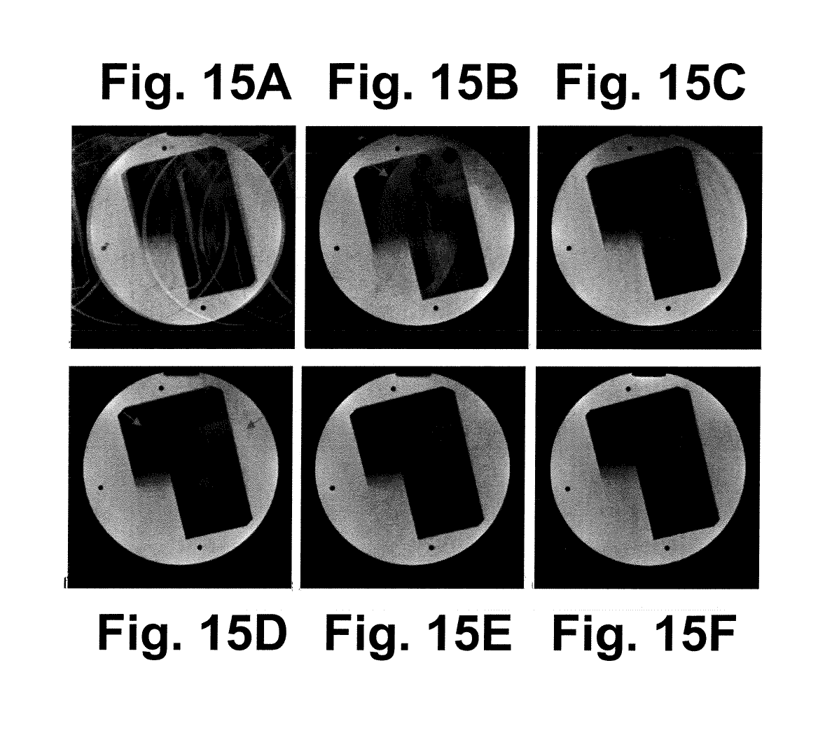

FIGS. 15A, 15B, 15C, 15D, 15E, and 15F show images from the phantom imaging experiment of FIGS. 14A and 14B. FIG. 15A shows a motion-corrupted image. FIG. 15B shows an image from interleaf no. 4, when conventional GRAPPA is applied. FIG. 15C shows an image from interleaf no. 4, when the high-pass GRAPPA is applied. FIG. 15D shows a motion-corrected image with conventional GRAPPA. FIG. 15E shows a motion-corrected image with high-pass GRAPPA. FIG. 15F shows a reference motion-free image.

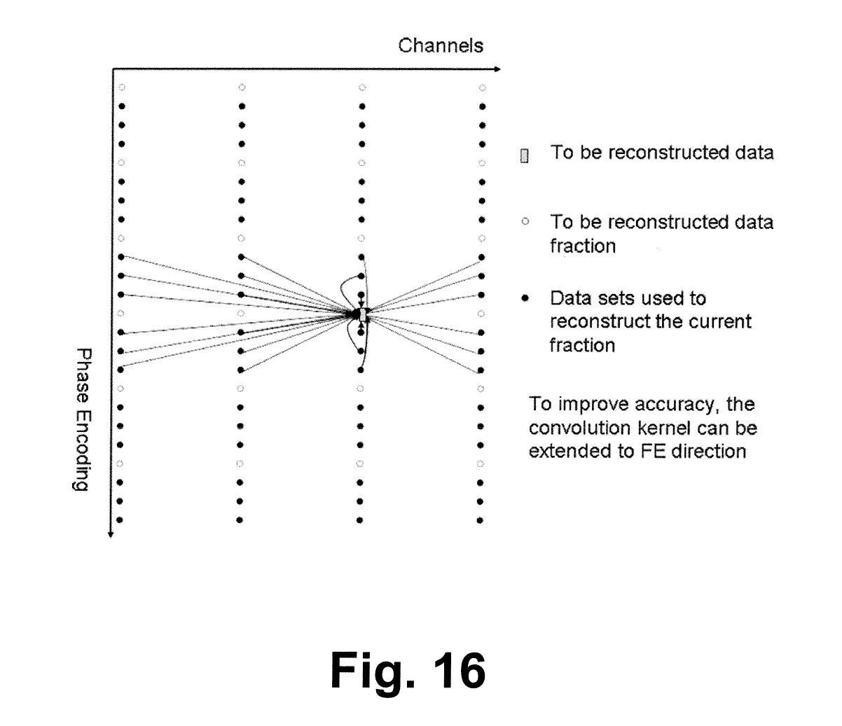

FIG. 16 diagrammatically illustrates an example of a parallel imaging based data correlation consistency operator used in kernel convolution nonrigid motion compensation as disclosed herein.

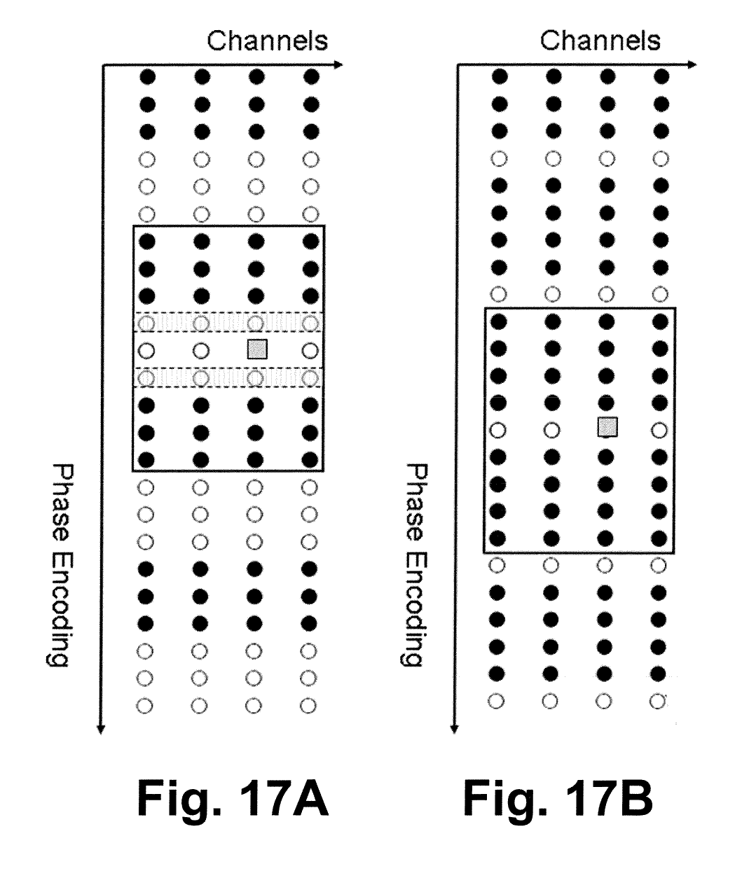

FIGS. 17A and 17B diagrammatically illustrate two suitable convolution kernels for kernel convolution nonrigid motion compensation of data acquired by a linear acquisition scheme. Notations are same as these in FIG. 16. The black points in the boxes defines the support of convolution kernel.

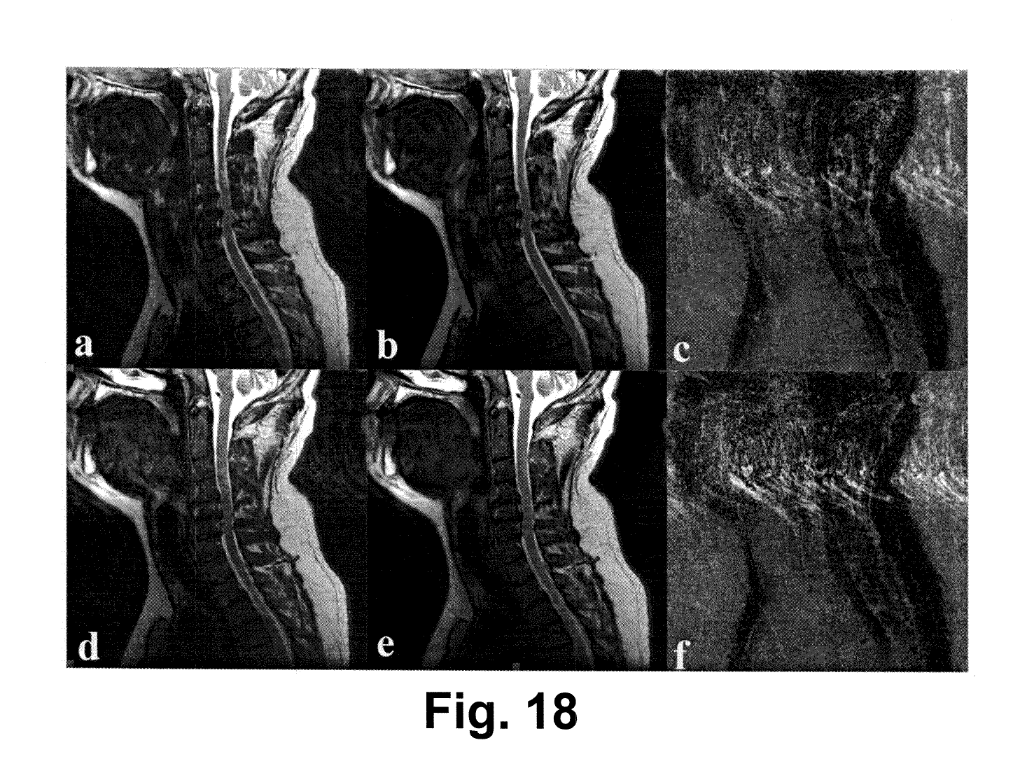

FIG. 18 shows motion correction results for images corrupted by swallowing. The first row (images (a)-(c)) and the second row (images (d)-(f)) are for slices 5 and 6 respectively. The left column (images (a) and (d)) show the images before correction. The middle column (images (b) and (e)) show images after correction. The same intensity scale was used. The difference maps in the right column (images (c) and (f)) are brightened 5 times for better visualization.

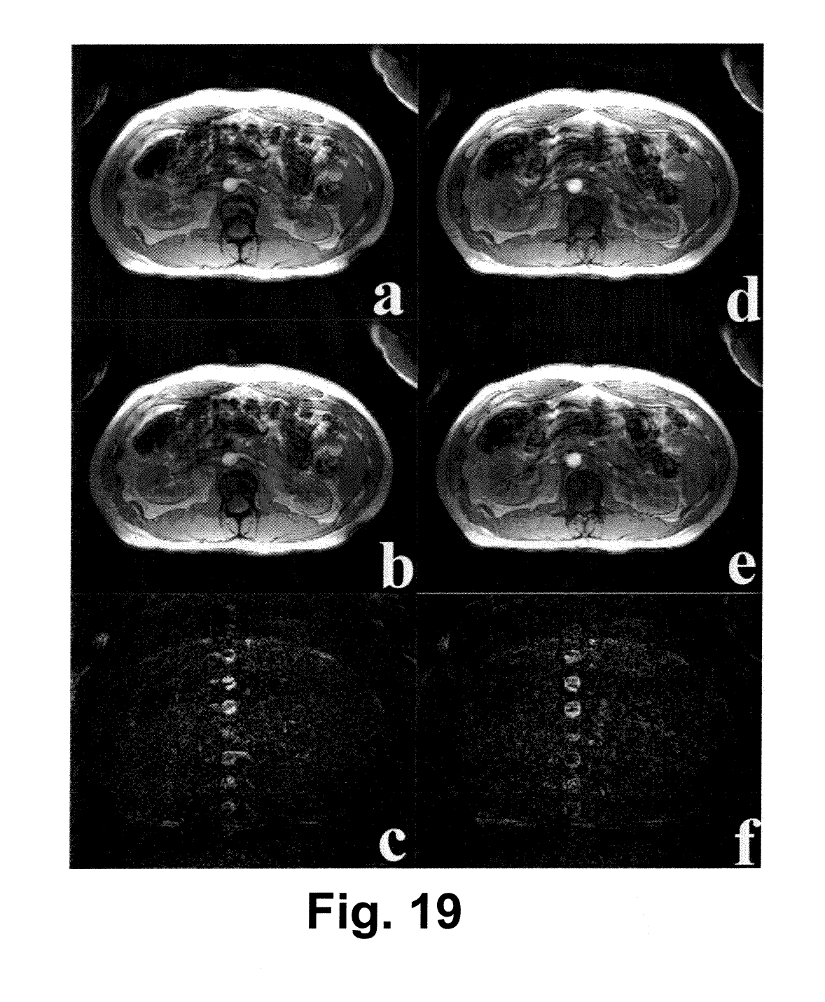

FIG. 19 shows motion correction results for images corrupted by flow. The left column (images (a), (b), and (c)) and the right column (images (e), (f), and (g)) are for two slices. The top row (images (a) and (d) show the images before correction. The middle row (images (b) and (e)) show the images after correction. The same intensity scale was used. The difference maps in the bottom row (images (c) and (f)) are brightened 5 times for better visualization.

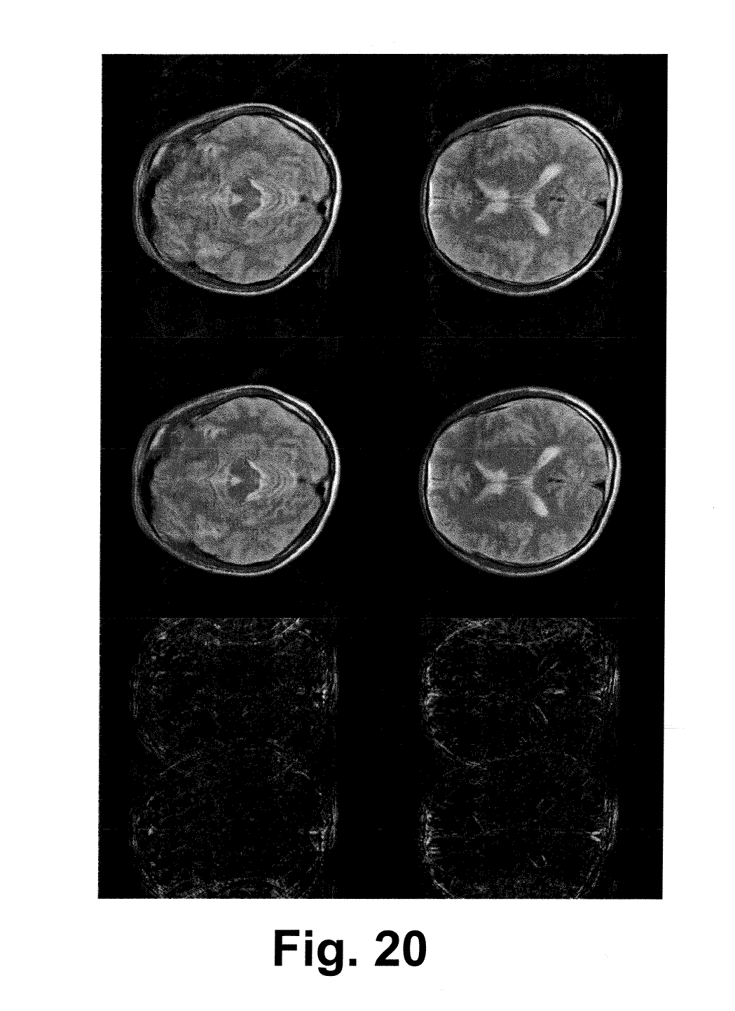

FIG. 20 shows motion correction results for images corrupted by random rigid motion. The two columns are for two slices. The top and middle rows show the images before and after correction respectively. The same intensity scale was used. The difference maps in the bottom row are brightened 5 times for better visualization.

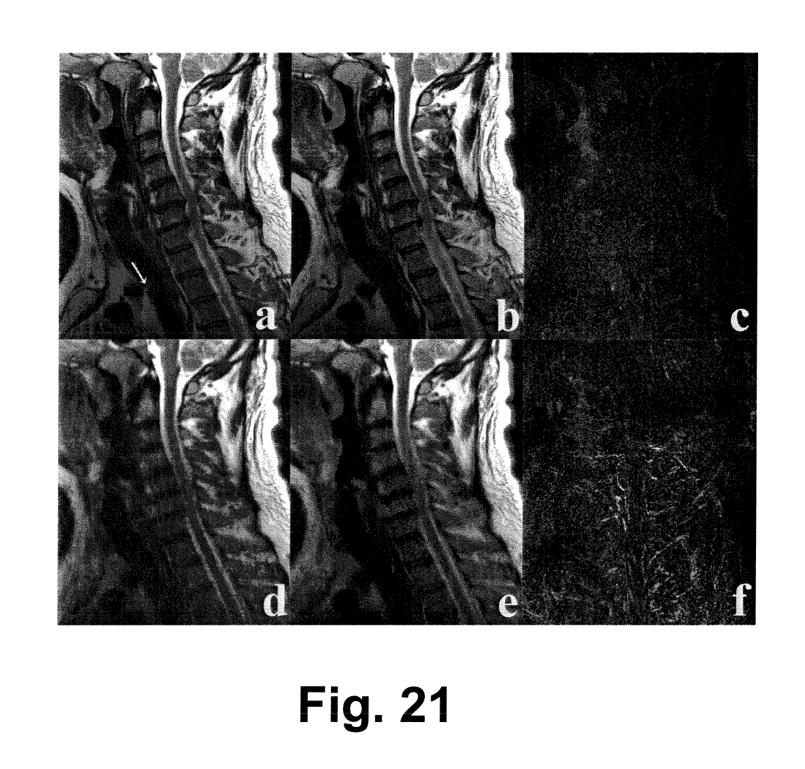

FIG. 21 shows results for substantial motion. The top row (images (a), (b), and (c)) show images for a slice without serious motion artifacts. The bottom row (images (d), (e), and (f)) show images for a slice with serious motion artifacts. The left column (images (a) and (d)) show images before correction. The middle column (images (b) and (e)) show images after correction. The same intensity scale was used. The difference maps in the right column (images (c) and (f)) are brightened 5 times for better visualization.

With reference to FIG. 1, an imaging system includes a magnetic resonance (MR) scanner 10, such as an illustrated Achieva™ MR scanner (available from Koninklijke Philips Electronics N.V., Eindhoven, The Netherlands), or an Intera™ or Panorama™ MR scanner (both also available from Koninklijke Philips Electronics N.V.), or another commercially available MR scanner, or a non-commercial MR scanner, or so forth. In a typical embodiment, the MR scanner includes internal components (not illustrated) such as a superconducting or resistive main magnet generating a static (B₀) magnetic field, sets of magnetic field gradient coil windings for superimposing selected magnetic field gradients on the static magnetic field, a radio frequency excitation system for generating a radiofrequency (B₁) field at a frequency selected to excite magnetic resonance (typically ¹H magnetic resonance, although excitation of another magnetic resonance nuclei or of multiple magnetic resonance nuclei is also contemplated), and a radio frequency receive system including a radio frequency receive coil, or an array or other plurality of two or more radio frequency receive coils, for detecting magnetic resonance signals emitted from the subject.

The MR scanner 10 is controlled by a magnetic resonance (MR) control module 12 to execute a magnetic resonance imaging scan sequence that defines the magnetic resonance excitation, spatial encoding typically generated by magnetic field gradients, and magnetic resonance signal readout. MR data in the form of k-space data are stored in a k-space data memory 14, and are reconstructed by a reconstruction processor 16 to generate a reconstructed image that is stored in a reconstructed image memory 18. In the illustrated embodiment, processing and control modules 12, 16 and memories 14, 18 are embodied by an illustrated computer 20 whose processor (which may be a multi-core processor or other parallel processing digital processing device) is programmed to implement the control and processing functions of the modules 12, 16 and which has a hard drive, optical drive, random access memory (RAM), or other storage medium implementing the memories 14, 18 and storing instructions executable to perform the control and processing functions of the modules 12, 16. The illustrated computer 20 also has a display 22 for displaying MR images and other visual information. In other embodiments, a dedicated MR controller, MR reconstruction system, or other digital device or devices is employed to embody the processing and/or storage 12, 14, 16, 18.

The MR imaging system of FIG. 1 is configured to implement detection and compensation of subject motion including in-plane translational and rotational motion, through-plane motion, and both rigid and non-rigid motion. It is recognized herein that rigid and non-rigid motion are fundamentally different, and accordingly are processed using different compensation mechanisms in the system of FIG. 1. Rigid motion is detected by a subject position assessment module 30 that compares or correlates a reference k-space line or floating navigator (FNAV) 32 that is acquired before imaging to provide a subject position reference P_{ref} with a reference k-space region R_{current} 34 that is acquired with a magnetic resonance (MR) imaging data set 36. The detected rigid motion includes an in-plane offset (Δx, Δy) 40, an in-plane subject rotation (θ) 42, and an estimate or weight indicative of through-plane motion 44. This positional information is compensated during reconstruction performed by phase correction for translation compensation 48, and k-space signal extrapolation for rotation compensation. A k-space signal extrapolation performed by the motion compensation module 48 uses a GRAPPA operator 50, where the acronym “GRAPPA” stands for “generalized auto-calibrating partially parallel acquisition”. It is disclosed herein to use GRAPPA to extrapolate k-space data that is missing due to subject rotation. It is also disclosed herein that by using a high-pass GRAPPA algorithm, through-plane motion is substantially compensated. Advantageously, the GRAPPA algorithm makes use of one or more auto-calibration signal (ACS) k-space lines that are conveniently acquired together with, or optionally comprise part of, the reference k-space region R_{current}.

The FNAV-based motion detection and corresponding GRAPPA-based motion compensation 48 is effective at compensating for rigid subject motion so as to produce an MR data set 52 with rigid motion compensation, but is less effective at compensating for non-rigid motions such as may occur during internal biological operations such as respiration, cardiac cycling, swallowing, and so forth.

In the illustrative embodiment of FIG. 1, a kernel convolution nonrigid motion compensation module 60 performs non-rigid motion compensation. More generally, it is disclosed herein that consistent correlations between k-space data of the MR imaging data set can be used to effectively compensate for non-rigid motion. The term “consistent correlation” is used herein to indicate a correlation that is locally similar as seen from any point in k-space. In other words, if a correlation is a consistent correlation, then for any selected point in k-space the consistent correlation is expected to be seen in about the same way relative to the selected point in k-space. It is disclosed herein that a consistent correlation is degraded or destroyed by local, for example non-rigid, motion. As a result, by combining consistently correlated points in k-space across the MR imaging data set, local motion, that is, non-rigid motion, can be effectively compensated. In the illustrative embodiments, combination of consistently correlated k-space data is achieved by convolving the MR imaging data set with a kernel embodying the at least one consistent correlation of k-space data of the MR imaging data set. The kernel is suitably chosen as a linear combination of correlated k-space data. However, other combinational algorithms are also contemplated. For example, the combination of k-space data that are consistently correlated by a partial Fourier correlation of neighboring k-space data points may be achieved using Cuppen's algorithm, rather than using a linear kernel-based convolution.

The data with rigid and non-rigid motion correction identified by the assessment module 30 and compensated or corrected by the modules 48, 60 are reconstructed by a reconstruction algorithm 62 to generate the a reconstructed image that may be displayed on the display 22 or otherwise utilized.

With reference to FIGS. 2-4, an overview of the motion detection performed by the subject position assessment module 30 of FIG. 1 is described. The reference k-space line or floating navigator FNAV 32, denoted P_{ref}, is acquired before commencement of acquisition of the imaging data. During acquisition of the MR imaging data, the reference k-space region R_{current} 34 is acquired. In the illustrative example of FIG. 3, these acquisitions are designed so that the region k-space data R_{current} spans a two-dimensional k-space region that encompasses the reference k-space data P_{ref} in the absence of subject motion. In this illustrative embodiment, the reference k-space data P_{ref} is a line in k-space, while the region k-space data R_{current} spans a rectangular two-dimensional k-space region centered on P_{ref}. Since the reference k-space data P_{ref} 32 is acquired before subject imaging commences, any rigid subject motion occurring thereafter will be seen as a change in position and/or phase of the current region k-space data R_{current} 34 respective to the fixed reference k-space data P_{ref}.

FIG. 4 shows the example of subject rotation, specifically a counterclockwise subject rotation of magnitude 5° (five degrees). Here the value of having the current region k-space data R_{current} be two-dimensional is apparent. If the current region k-space data R_{current} was a single line, then its intersection with the reference k-space line P_{ref} would be a single point, making correlation of the current region k-space data and the reference k-space line unfeasible. By having the current region k-space data R_{current} 34 be two-dimensional, as shown in FIG. 4, a complete overlap with the reference k-space line P_{ref} 32 continues to be present, making correlation between the current region k-space data R_{current} and the reference k-space line P_{ref} feasible. As diagrammatically indicated in FIG. 2, a correlation operation 70 is performed to find the best correlation of the reference k-space line P_{ref} to the current (reference) k-space region R_{current} 34. The correlation 70 yields a best fit translational offset along the reference k-space line P_{ref}, denoted as translational position (Δx) 40x (which is one component of the two-dimensional in-plane translation 40 of FIG. 1) and a best fit in-plane angle denoted herein as the subject rotation (θ) which is the in-plane rotation 42 of FIG. 1. As further diagrammatically indicated in FIG. 2, a phase identification operation 72 finds the phase of the best fit correlation which yields the translational offset transverse to the reference k-space line P_{ref}, denoted as translational position (Δy) 40y (which is the other component of the two-dimensional in-plane translation 40 of FIG. 1).

As also further diagrammatically indicated in FIG. 2, an operation 74 determines the magnitude or strength of the best fit correlation, that is, the measure of how highly correlated the reference k-space line P_{ref} is with the current region k-space data R_{current} at offset (Δx) and rotation (θ). The magnitude or strength of the best fit correlation is a measure of the through-plane subject motion 44. (This is relevant for embodiments in which the MR imaging data set is two-dimensional). The rationale for identifying reduced correlation strength with through-plane motion is that in the absence of through-plane subject motion the correlation should be high since the data is uncorrupted and any in-plane translation or rotation is accounted for by the correlation operation, whereas through-plane motion manifests as “corruption” of the data in the plane of the acquired MR imaging data set.

With reference to FIG. 5, an overview of the nonrigid motion compensation performed by the kernel convolution nonrigid motion compensation module 60 of FIG. 1 is described. The non-rigid motion compensation entails a kernel convolution operation 80 that convolves the MR imaging data set 52 with a kernel 82 comprising a linear combination of k-space data embodying at least one consistent correlation of k-space data of the MR imaging data set. For a suitably chosen kernel 82, the kernel convolution operation 80 produces an MR imaging data set 84 with reduced non-rigid motion artifacts. The kernel 82 is selected to embody one or more consistent correlations. For example, it is expected that the k-space data 52 exhibit a consistent conjugate symmetric k-space correlation. Thus, the kernel 82 may include a term incorporating the conjugate symmetric k-space data point. It is also expected that the k-space data 52 exhibit a consistent correlation of spatially neighboring k-space data. Thus, the kernel 82 may include one or more terms incorporating one or more spatially neighboring k-space data, with selected linear combination weights. If the MR imaging data set 52 is a PPI MR imaging data set acquired using a plurality of independent MR signal acquisition channels, then the kernel 82 optionally embodies a consistent correlation of k-space data acquired using different MR signal acquisition channels.

With returning reference to FIG. 1, the reconstruction algorithm 62 employs any suitable reconstruction algorithm, such as Fourier transform-based reconstruction. Rigid subject motion is globally compensated for by phase correction and data extrapolation performed by the rigid motion correction module 48 as described with reference to FIGS. 2-4 using rigid translational and rotational motion values determined by the subject position assessment module 30, and optionally including data weightings corresponding to a measure of through-plane subject motion 44 estimated based on the strength of correlation between the reference k-space data P_{ref} 32 and the reference k-space region R_{current} 34. Optionally, high-pass GRAPPA 50 is used to compensate for through-plane subject motion, either alone or in combination with data weighting based on correlation strength. Non-rigid subject motion is compensated by the kernel convolution nonrigid motion compensation module 52 as described with reference to FIG. 5. The resulting motion-compensated image is suitably displayed on the display 22 of the computer 20. The resulting motion-compensated image may also be stored in the reconstructed image memory 18 or otherwise utilized.

The various processors 12, 16 are suitably embodied by the computer 20 or by another digital processing device. In storage medium embodiments, a storage medium such as a hard disk or other magnetic storage medium, an optical disk or other optical storage medium, a random access memory (RAM), FLASH memory, or other electronic memory, or so forth stores instructions that are executable by the digital processor of the computer 20 or by another digital processor to implement the operations described herein with reference to the various processors 12, 16.

Some further disclosure of the subject position assessment module 30 (FIGS. 1-4) is now set forth. In this further disclosure, the symbol P_{moved} is sometimes used in place of the reference or current k-space region R_{current} 34 that is acquired with a magnetic resonance (MR) imaging data set 36, in order to provide a more visually symmetric notation for the mathematical description.

With reference to FIG. 6A, unlike some navigator techniques which involve acquiring signal along the k_{y}=0 line, the reference k-space line FNAV 32 samples along k_{y}=k_{f}≠0, where k_{f} is typically small to ensure a sufficient signal-to-noise ratio (SNR) and to avoid phase-wrapping along y-direction. The FNAV signal is:

F(kₓ)=∫∫f(x,y)·e^{-j2π(k}^{ₓ}^{x+k}^{_{f}}^{y})dxdy [1]

Taking a 1-D inverse FT along kₓ direction, the following complex “generalized projection” is acquired for the FNAV line of Equation [1]:

P(x)=∫f(x,y)·e^{-j2πk}^{_{f}}^{y}dy [2]

If 2D in-plane translation of (Δx, Δy) is present while acquiring FNAV signal, then:

P_{Δx,Δy}(x)=∫f(x−Δx,y−Δy)·e^{-j2πk}^{_{f}}^{y}dy=e^{-j2πk}^{_{f}}^{Δy}P_{0,0}(x−Δx) [3]

Here the subscript denotes the amount of motion. Therefore 2D in-plane translation introduces both a shift of signal profile (depending on Δx) and an additional complex phase factor (depending on Δy) for the projection.

A suitable normalized correlation function for motion detection (e.g., operation 70 of FIG. 2) is:

$$C ( x ) = \frac{{P}_{moved} * {P}_{ref}}{\vert {P}_{moved} \vert \cdot \vert {P}_{ref} \vert} \qquad [ 4 ]$$

Here the asterisk (*) denotes cross correlation and the notation |·| denotes L2 norm. According to the cross-correlation theorem, the magnitude of C(x) is always less than or equal to 1. The latter is only attained at x=Δx when:

P_{moved}(x)=P_{ref}(x−Δx)e^{jφ} [5]

In other words, the magnitude of correlation will be 1 when there is only 2D in-plane translation present. The best fit offset along the x-direction (Δx) 40x is detected by the location of the correlation maxima, while the offset along the y-direction (Δy) 40y is determined (e.g., operation 72 of FIG. 2) from the phase of the maximum correlation by:

Δy=−φ/2πk_{f} [6]

Equation [6] shows that there is a tradeoff between the range and the accuracy of Δy detection concerning the selection of k_{f} value, or the phase-encoding position for FNAV line. The range of unambiguous Δy determination without any phase wrapping is 1/k_{f}. Therefore a smaller k_{f} allows a larger range for Δy detection. A FNAV line with a smaller k_{f} value also has a higher signal to noise ratio (SNR). On the other hand, a smaller k_{f} amplifies the phase error in φ more dramatically, resulting in higher Δy error. A moderate value such as k_{f}=8/FOV is suitable for typical applications.

With continuing reference to FIG. 6A and with further reference to FIG. 6B, while translation only introduces a linear phase factor to the k-space data, rotation caused the same amount of rotation in k-space. It is disclosed herein to acquire the reference k-space region 34 near the FNAV line 32 to facilitate correlating P_{moved} 34 with multiple copies of P_{ref}, each corresponding to the FNAV line position when the entire k-space is rotated to different angles as shown for in FIG. 6B. The global correlation maximum then yields both rotation and 2D translation:

$$\begin{matrix}( Δθ , Δ x ) = {arg max}_{θ , x} \vert C ( θ , x ) \vert , & C ( θ , x ) = \frac{{P}_{moved} * {P}_{ref} ( θ )}{\vert {P}_{moved} \vert \cdot \vert {P}_{ref} ( θ ) \vert} .\end{matrix} \qquad [ 7 ]$$

Here θ is k-space rotation angle. Once again, Δy (operation 72 of FIG. 2) can be determined from the phase of the maximum correlation according to Eq. [6]. The width of FNAV reference region 34 (that is, the gray rectangles in FIGS. 6A and 6B) can be determined by the desired search range θᵣ for rotation and matrix size along readout direction Nₓ, so that FNAV line 32 always remains within the rotated reference region 34 (see FIG. 6B):

Δk_{y}=Nₓ tan(θᵣ/2)/FOV [8]

For example, if readout matrix size is 256 and the rotation search range is 10°, then Δk_{y}=22/FOV. In practice, a smaller reference region around FNAV line is usually sufficient due to the reduced signal contribution near the edge of the k-space.

With reference to FIGS. 7A and 7B, the sensitivity of rotational motion detection using FNAV increases when k_{f} increases. For the same amount of rotation, the position of FNAV lines with a larger k_{f} value was shifted by a larger amount in the azimuthal direction. Another way to look at this problem is to compare the signal profile of generalize projections. FIG. 7A compares the magnitude of the generalized projection of FNAV lines at different k_{f} values, using a brain image. Since FNAV lines with larger k_{f} values contain more high-frequency information, they are more sensitive to changes in signal profiles due to rotation. This is confirmed by the profile of maximum correlation vs. rotation angles, as shown in FIG. 7B. However, SNR consideration once again favors a moderate k_{f} value, such as k_{f}=8/FOV.

When only in-plane rotation and translation is present, the correlation measure (e.g., Equation [4] or Equation [7]) will yield a magnitude close to 1 at the correct rotation angle and shift along readout direction. However, if motion (e.g. through-plane motion) destroys the consistency of the k-space data, the magnitude of the maximum correlation measure will be less than 1. Since it still gauges the similarity between motion-corrupted and reference k-space data, it can still be used to reject or weight these inconsistent data. Since the correlation in image space is equivalent to multiplication in k-space, the computation cost of the motion detection for each FNAV line is a 1D FT for each rotation angles searched, in addition to the shared overall cost to rotate the reference data to various angles.

With reference to FIGS. 8A and 8B, reconstruction of motion corrupted data with the GRAPPA operator 50 (FIG. 1) is described. Two illustrative methods for the reconstruction of motion-corrupted data with GRAPPA operators are disclosed herein. The first method uses GRAPPA operators to extrapolate each acquired readout lines along phase-encode direction. This method is particularly effective in filling missing “pie-slice” of k-space caused by rotational motion, as shown in FIG. 8A. The width of extrapolation region (light gray rectangle in FIG. 8A) is determined by the number of coil elements and their sensitivity profiles. A phase array with a high acceleration capability will allow a wider extrapolation band, therefore allowing more filling area in k-space. This method is applicable for k-space data acquired in arbitrary phase-encode ordering.

A second illustrative method for using the GRAPPA operator in the reconstruction is only applicable to k-space acquired in an interleaved manner (FIG. 8B). The number of interleaves is determined by the accelerating capability of the phase-array coil elements. Different interleaves are acquired sequentially to cover the entire k-space. For an interleaf with a consistent object position, GRAPPA interpolation operator is directly applied to regenerate a full k-space. This full k-space can then be corrected for both translational and rotational motion by applying proper linear phase factors and data rotation. For an interleaf with internal motion, data can be either corrected with the first method (for rotation/translation), or replaced with data from other interleaves (for through-plane/non-rigid motion), prior to the application of GRAPPA interpolation. Finally, multiple full k-spaces from different interleaves are combined prior to the final inverse Fourier Transform. In a suitable illustrative embodiment, the following empirical weight is used according to the average maximum correlation values for each interleave:

$$w = \{ \begin{matrix}0 & if {C}_{m} < 0.9 \\ ( {C}_{m} - 0.9 ) * 10 & if 0.9 < {C}_{m} < 1\end{matrix} \qquad [ 9 ]$$

The disclosed motion correction or compensation techniques were investigated using MR imaging experiments. A conventional turbo spin-echo (TSE) sequence was modified to examine the motion correction capability of the disclosed method. Within each echo train, an additional echo is acquired at FNAV line position prior to other normal imaging echoes. Since FNAV reference data and GRAPPA auto-calibration signal (ACS) both occupy a region near k-space center, they are jointly acquired before the actual imaging phase-encoding steps, using one or more echo trains. To reduce possible interference to motion detection accuracy introduced by the T₂ decay within a single echo train, these reference echo trains are acquired in a center-out manner, with the first echo train centering on the desired FNAV line position (k_{f}).

To validate the rotational motion detection capability of the disclosed FNAV method, a phantom experiment is first carried out using the modified TSE sequence on a 3.0T Achieva scanner (Philips, Best, Netherlands). The prescribed imaging orientation was rotated to various angles in the range of [0°,10°] with 2° increments. FNAV data were then processed to determine the rotation angle and compared with the gold standard.

In vivo brain, knee and spine motion correction imaging experiments were also carried out on the same system, using an 8-element head coil, an 8-element knee coil and an 16-channel spine coil (Invivo, Gainesville Fla.), with following scan parameters: FOV 230×230 mm² (head), 200×200 mm² (knee), 250×250 mm² (spine), matrix size 256×256, Echo train length (ETL)=16. Both T₁ and T₂ weighted images were acquired. T₁-weighted images were acquired using relatively shorter TRs and center-out echo ordering with short TE, while T₂-weighted images were acquired using longer TRs and linear echo ordering with longer TE. Based on consideration regarding motion detection sensitivity and robustness discussed earlier, the k_{f} values of FNAV lines was set at 8/FOV. The calibration data for GRAPPA, which also contains FNAV reference data, is the central 32 phase encoding lines acquired with two echo-trains. A motion-free reference scan was first acquired and a motion-corrupted scan followed by requesting the volunteer to randomly move inside the scanner.

Following data acquisition, raw data was saved and processed. A shearing method (Eddy et al., “Improved image registration by using Fourier interpolation”, Magn. Reson, Med. vol. 36 pages 923-31, 1996) is used to rotate FNAV reference region to various angles prior to the computation of maximum correlation. GRAPPA extrapolation operators used a 5 (readout)×1 (phase-encode) kernel with an extrapolation factor of 5, while GRAPPA interpolation operators used a 5 (readout)×4 (phase-encode) kernel with a reduction factor R=4. The typical computation time of the disclosed method was about 10 seconds for each imaging slice on a 2.2 GHz PC.

The performance of a previously proposed high-pass GRAPPA technique (Huang et al., “High-pass GRAPPA: an image support reduction technique for improved partially paralle imaging”, Man. Reson. Med. Vol. 59 pages 642-49, 2008) was also investigated in a separate phantom imaging experiment. High-pass GRAPPA is a method to improve the performance of GRAPPA through the reduction of image support, by applying a high-pass filter to the ACS lines prior to the normal calibration process. In this experiment, the phantom was imaged with an 8-channel head coil and manually moved several times during the course of the scan.

With reference to FIG. 9, validation results for the disclosed FNAV technique are discussed. FIG. 9 shows the phantom experimental results to validate the rotation detection accuracy for the enhanced FNAV method (that is, the operation of the assessment module 30 in detecting the in-plane rotation 42). It is seen that FNAV is able to accurately detect rotation up to 10°. The average maximum correlation for six angles studied is 0.998. Notice that although theoretically a FNAV reference region with 45 views (according to Equation [8]) is needed to detect a rotation range of ±10°, a much smaller number of views (32, with only 8 views on one side of the FNAV line) is sufficient in this case. This demonstrates that data near the edge of k-space has a minimal contribution to the accuracy of the correlation method for motion detection disclosed herein.

With reference to FIGS. 10A, 10B, and 10C, the in vivo imaging experiments the disclosed motion correction significantly reduced the motion artifact and improved the image quality. FIGS. 10A, 10B, and 10C show results from a knee imaging experiment, where data was acquired in a linear order along the phase-encode direction. Motion introduces severe ghosting and blurring artifacts (FIG. 10B), which severely degrades the overall image quality. After motion correction with the disclosed method, the majority of motion artifacts were successfully removed (FIG. 10C), resulting in an image quality comparable with the image acquired when the subject did not move (FIG. 10A). The range of in-plane rotation detected by the enhanced FNAV method is around 3.0° for the entire imaging volume (20 slices).

With reference to FIGS. 11A-11D and FIG. 12, the flexibility to trade the artifact level with the SNR, when the data is acquired in an interleaved manner, is demonstrated with results from a brain imaging experiment. This dataset was acquired with an 8-element head coil array and an interleave factor of 4. Compared with motion-free image (FIG. 11A), motion-corrupted image exhibits strong ghosting artifacts (FIG. 11B). In-plane rotation detected from FNAV data shows that the amount of motions within each interleaves are quite different (FIG. 12). When all four interleaves were used for the final reconstruction, SNR is maximized (FIG. 11C). However, some residual artifacts exist, due to intra-leaf motion within interleaves no. 1 and 3. If these two interleaves are excluded from the final reconstruction, then artifact is further reduced, at a cost of slightly lower SNR (FIG. 11D).

With reference to FIGS. 13A, 13B, and 13C, the capability of the disclosed method to correct for non-rigid body motion is demonstrated in a spine imaging experiment. Since the prescribed imaging volume contains both head and cervical spine, the nodding motion is intrinsically non-rigid body motion. FIG. 13A shows a motion-free image. Motion introduce severe ghosting artifacts (FIG. 13B), which is significantly reduced with the disclosed motion correction method (FIG. 13C).

With reference to FIGS. 14A and 14B and FIGS. 15A-F, experimental results validating the disclosed through-plane motion correction with high-pass GRAPPA are set forth. Results from the phantom experiment demonstrated the unique property of high-pass GRAPPA technique to alleviate data inconsistency introduced by through-plane motion. FIG. 14A plots the maximum correlation derived from FNAV lines for all eight coil elements. It can be seen that towards the end of data acquisition (interleaf no. 4), two coil elements yields low correlation values (<0.9), indicating data inconsistency introduced by through-plane motion. As a result, in-plane rotations detected from these two elements are different from others (FIG. 14B). When conventional GRAPPA method is used to reconstruct image for interleaf no. 4, significant artifact due to through-plane motion is visible (FIG. 15B). With high-pass GRAPPA, however, the majority of through-plane artifact is eliminated (FIG. 15C). When data from all interleaves were combined, significant through-plane motion artifacts remain when conventional GRAPPA operations were carried out (FIG. 15D). In contrast, high-pass GRAPPA generates an image quality (FIG. 15E) comparable with the reference motion-free acquisition (FIG. 15F).

The disclosed motion correction was shown to be effective in a variety of motion correction applications, by combining the motion detection capability of the enhanced FNAV and the reconstruction flexibility provided by the GRAPPA operators. Since both FNAV reference and GRAPPA calibration employ data near k-space center, it is convenient to acquire them jointly before the actual phase-encoding steps. The enhanced FNAV method was shown to detect in-plane rotation in a robust manner. The disclosed correlation function also provides gauge of the consistency of the data, therefore and thus enables the alleviation of through-plane and non-rigid body motion artifacts.

Two methods for the reconstruction of motion-corrupted data with GRAPPA operators are disclosed herein, depending on whether data is acquired linearly or interleaved along the phase-encode direction. If data is acquired linearly, GRAPPA extrapolation is used to fill in missing “pie-slice” of k-space. If data is acquired in an interleaved manner, multiple full k-spaces can be generated using GRAPPA interpolation prior to subsequent correction. Since GRAPPA extrapolation is most accurate for data point near the acquired k-space line, linear acquisition scheme is suited for continuous motion. Interleaved acquisition is suited for large, sudden motion where correction can be applied separately for each interleaf after the re-generation of the full k-space. The approach to rotational reconstruction disclosed herein is to compute k-space data points on a rotated grid followed by data rotation. Another contemplated approach is GRAPPA operator gridding (GROG) (see Seiberlich et al., “Non-cartesian data reconstruction using GRAPPA operator girding (GROG)”, Magn. Reson. Med. vol. 58 pages 1257-65, 2007).

The phantom experiment results demonstrate that high-pass GRAPPA is capable of mitigating through-plane motion artifacts. Without being limited to any particular theory of operation, the basis for this effect is believed to be as follows. Application of a high-pass filter to the ACS lines reduces the image support. Therefore only coil sensitivity information along the edges of the original image (without through-plane motion) is retained. Consequently little coil sensitivity information is available along new edges introduced by the through-plane motion. This results in a reduction of through-plane motion artifacts.

The disclosed motion correction methodology can be incorporated into sequences other than turbo spin-echo (TSE), provided that a FNAV line is acquired at the desired temporal resolution for motion detection. TSE has an advantage in that FNAV reference data is acquired with a very small number of echo trains (e.g. two), thus reducing the likelihood that motion occurs during the acquisition of reference data.

Some further disclosure of the kernel convolution module 60 for nonrigid motion compensation (FIGS. 1 and 5) is now set forth. This aspect is based on the presence of some strong correlations among k-space data from different locations, channels, and time frames. Many of these data correlations are consistent in the whole k-space domain. However, if there are motions during acquisition, these consistent correlations will be corrupted. It is recognized herein that using consistent correlation as a constraint can reduce motion artifacts. One way to apply the constraint is to design a consistent correlation operator to reconstruct a new set of k-space data which follows the correlation consistent constraint. In the following, consistent correlation among data from multiple channels is used as an illustrative example—however, more generally any correlation that is expected to be consistent over the k-space domain can be similarly used.

The illustrative parallel imaging based correlation consistent operator is designed with the assumption that the motion corrupted full k-space data from multiple channels are available. With multi-channel data sets, the correlation among k-space data from multiple channels can be approximated by linear combination. The correlation is consistent in k-space. The parallel imaging based correlation consistency operator can be defined as a convolution in k-space.

With reference back to FIG. 5 and with further reference to FIG. 16, one example of the illustrative parallel imaging based correlation consistent operator is diagrammatically shown. Applying the operator to the MR imaging data set 52 by convolution in k-space (operation 80 shown in FIG. 5) produces the new k-space data set 84. This data set is generated using the correlation consistency. Hence it contains reduced artifacts due to correlation non-consistency. From the design of the illustrative operator of FIG. 16, it can be seen that this operation uses parallel imaging with acceleration factor 1.3. Therefore, the g-factor (see, e.g. Pruessmann et al., “SENSE: Sensitivity encoding for fast MRI”, Magn. Reson. Med. vol. 42 pages 952-62, 1999) will be close to 1 and the operation will not reduce image SNR. After the definition of the size and shape of the operator, it can be calculated with the motion corrupted data through data fitting (see, e.g. Griswold et al., “Generalized Autocalibrating Partially Parallel Acquisitions (GRAPPA)”, Magn. Reson. Med. vol. 47:1202-10, 2002). Even though the available data is corrupted by motion, the data fitting in the least square sense has an average effect and the calculated operator can be used as an approximation.

Various approaches can be used to determine the convolution kernel. Since there are full k-space data available, the design of operator is flexible. For better balance motion correction, SNR preservation and computation time, there are several general rules for kernel design. First, for better motion correction, the convolution kernel should large enough to contain sufficient motion-free data or data with different types of motion. If possible, the kernel should not contain data with the same type of motion. Second, to preserve SNR, the convolution kernel support should contain data with strong correlation with the to-be reconstructed data. Usually, the closer neighbors have stronger correlation. Therefore, the convolution kernel support should contain closest neighbors once possible. Besides the closest neighbors, the conjugate of the data located at the symmetric point also has strong correlation with the to-be reconstructed data. Hence the conjugate symmetric signal can also be included in the convolution kernel support. Third, the convolution kernel should not be too large. Larger convolution kernel takes longer reconstruction time. Following these rules, the design of convolution kernel can be optimized according to the acquisition scheme and the properties of potential motion in the application. As illustrative examples, two kinds of acquisition scheme (linear and interleaved) and two kinds of motion (random, pseudo-periodic) are considered herein.

With reference to FIGS. 17A and 17B, linear acquisition means that immediate adjacent phase encoding (PE) line is acquired one by one. Since it is possible that continuous multiple PE lines are corrupted by motion, the convolution kernel should be large enough to contain sufficient motion free data. If the data set is corrupted by pseudo-periodic motion (blood flow, by way of example), then the possibility that continuous PE lines contain motion artifacts is high. Hence the immediate adjacent PE lines should be avoided in the convolution kernel. FIG. 17A diagrammatically illustrates one suitable convolution kernel for data corrupted by pseudo-periodic motion. Notice the immediate adjacent neighbors, which are in the dashed boxes, are not used for convolution to reduce residual motion artifacts. FIG. 17B shows a kernel for data corrupted by random acquisition. If the dominant motion is random motion, then there is no any prior information of the motion. Hence convolution kernel covering more PE lines usually works better than smaller kernels. FIG. 17B shows one example of this.

Interleaved acquisition means that PE lines are divided into several fractions, and are acquired fraction by fraction. PE lines in each fraction are equally spaced, this space is called interleave factor. If interleave factor is 4, then PE lines 1, 5, 9, . . . , are first acquired, which follows lines 2, 6, 10, . . . , and so on. When all 4 fractions are acquired, the full k-space is filled. Since data are acquired fraction by fraction, it is reasonable to assume that the motion between fractions is more serious than in-fraction motion. This assumption is more reasonable when the data are acquired by Turbo spin echo sequence. Hence the convolution kernel should not use data from the same fraction, and only use data from other fractions to reconstruction the fraction under consideration. Therefore, the shape of the convolution kernel is decided by the interleave factor. FIG. 16 shows one example when interleave factor is 4. In this example, let interleave factor be R, data from upper R-1 lines and lower R-1 lines are used for reconstruction.

The disclosed non-rigid motion correction performed by the kernel convolution module 60 as described herein (e.g., with reference to FIG. 5, FIG. 16, and FIGS. 17A and 17B) was tested for data with various motion artifacts. Several experiments were designed to produce different motion artifacts, including: swallowing, blood flow, translation and rotation. Data acquired by both linear and interleaved acquisition schemes were tested.

In vivo cervical spine, abdomen, and brain data sets were acquired on a 3.0T Achieva scanner (Philips, Best, Netherlands), using a 16-element neuron vascular coil, a 32-element cardiac coil and a 8-channel head coil (all coils by Invivo Corp, Gainesville, Fla.) individually. The spine and brain data sets were acquired using interleaved acquisition scheme with interleave factor 4, while the abdomen data set was acquired using linear acquisition scheme. Cervical spine data sets were acquired by T2 weighted TSE sequence (FOV 200×248 mm, matrix size 256×256, TR/TE 3314/120 ms, flip angle 90°, Slice thickness 3 mm, Echo train length (ETL)=16). To produce swallow artifacts, the volunteer was told to swallow once every 10˜15 seconds and the PE direction was chosen as anterior-posterior (AP) direction. The axial abdomen data set was acquired using a breath hold dual fast field echo (FFE) sequence (FOV 375 mm, matrix size 204×256, TR 180 ms, TE1/TE2 2.3/5.8 ms, flip angle 80°, Slice thickness 7 mm) PE direction was also AP. No flow motion suppression technique was adopted during the acquisition. The brain images were acquired T2 weighted TSE sequence with following scan parameters: FOV 230×230 mm2 (head), matrix size 256×256, Echo train length (ETL)=16. The volunteer was told to randomly move heads during the acquisition.

To test the robustness of the disclosed method in an extreme scenario, two extra sets of cervical spine data sets were acquired. The volunteer was told to keep still during the acquisition of the first data set, to move randomly and intensively during the acquisition of the second data set. The two extra data sets were also acquired on a 3.0T Achieva scanner using a 16-element neuron vascular coil. Different from the previous spine data set, PE direction of these two data sets was head-to-feet. The acquisition parameters are: FOV 160×248 mm, matrix size 200×248, TR/TE 3314/120 ms, flip angle 90°, Slice thickness 3 mm, Echo train length (ETL)=16.

The choice of the kernel 82 for use in the kernel convolution operation 80 (see FIG. 5) was based on the expected consistent correlation of the data set. Since spine and brain data sets were acquired with interleave factor 4, the correlation consistency operator was defined as convolution with the kernel of FIG. 16. Since the abdomen data set was acquired with linear acquisition scheme and flow motion is pseudo-periodic, the convolution kernel of FIG. 17A was used as correlation consistency operator for this data set. To adopt the sensitivity maps variation along frequency encoding (FE) direction, the convolution kernels were extended to immediate adjacent neighbors along FE direction, i.e. each black dots in FIGS. 16 and 17A and 17B denote 3 adjacent signals in k-space. Correlation consistency operators were calculated through data fitting with the central 64 k-space lines from the motion corrupted data. By applying the correlation consistency operator, new k-space data sets were produced for each channel. Square root of sum of squares of images from each coil element was used as the final reconstruction. It should be clarified that the original k-space data was not used in the final reconstruction for two reasons. First, because of the design of the convolution kernel, SNR can be well-preserved. Hence it is not necessary to use original k-space data to improve SNR. Second, original k-space data was corrupted by motion. Using original k-space data will introduce more residual motion artifacts.

To evaluate the image quality of the reconstructed images, the difference map was used. The difference map depicts the difference in magnitudes between the reconstructions before and after motion correction. The difference map can show the reduction of motion artifact and the preservation of diagnostically useful information. All data were processed on a workstation with dual 3.2 GHz processors and 2 GB RAM.

With reference to FIG. 18, results for images corrupted by motion due to swallowing are described. FIG. 18 shows the results of cervical spine imaging. From the comparison of the first two columns, it can be seen that the artifacts due to swallowing were significantly reduced. From the difference maps shown in the right column, it can be seen that no image structures were removed by the non-rigid motion compensation. The SNR and diagnostically useful information were well preserved. Advantageously, the background noise was also suppressed by the correlation consistency operator. This background noise suppression results in better contrast to noise ratio (CNR). Without being limited to any particular theory of operation, it is believed that this background noise suppression is obtained because the noise also introduces correlation inconsistency. Therefore, the constraint on correlation consistency also reduces noise level.

With reference to FIG. 19, results for images corrupted by blood flow are described. In this experiment, flow artifacts in abdomen imaging were dramatically reduced at the cost of slightly reduced SNR. FIG. 19 shows the results. The reduction on SNR is because that the convolution kernel support (FIG. 17A) does not include immediate neighbors to sufficiently suppress pseudo-periodic motion artifacts.

With reference to FIG. 20, results for images corrupted by random rigid motion are described. Brain imaging data set was used to test the performance of the disclosed method for rigid motion. FIG. 20 shows the results. In this example, most of the ghosts due to rigid motion were removed. Also, the SNR was well preserved. This demonstrates that the proposed method can not only reduce non-rigid but also rigid motion artifacts.

With reference to FIG. 21, results for images corrupted by an extreme motion scenario are described. Two spine data sets were used for this experiment. Images in one data set are almost motion-free. The aim of the experiment with this data set was to test whether the proposed method will reduce the image quality when the original image quality is high. Images in the other data set have serious rigid and non-rigid motion artifacts. The aim of the experiment with this data set is to test if the severely corrupted calibration signal can still be used for convolution kernel calculation. FIG. 21 demonstrates the results. From the first row, it can be seen that image quality was well preserved for images without motion artifacts. Furthermore, even slight inconsistency can be corrected by the disclosed method. When there are serious mixed motion artifacts, the image quality can still be significantly improved. The edge definition of abnormal spine vertebrae C4 and C5 was enhanced after motion correction.

The motion correction performed by the kernel convolution module 60 uses data correlation consistency to reduce motion artifacts. The approach does not have any requirement on the acquisition sequence or trajectory. The approach also does not rely on the detected motion parameters—accordingly, there is no motion detection step. Still further, only one set 84 of new k-space data is produced and the original k-space data 52 (see FIG. 5) is not used in final reconstruction. The approach is robust and preserves SNR, and is applicable for both non-rigid and rigid motion reduction. For images without motion artifacts, the approach does not degrade the image quality. For images with serious artifacts the correlation consistency operator calculated from severely corrupted calibration signal can still significantly reduce motion artifacts. The experiments reported herein also support the robustness of the method. Respecting SNR, except abdomen imaging, the reduction factor was 1.3 in all experiments. Reduction factor 1.6 was used for abdomen imaging. Therefore, SNR reduction is neglectable. Furthermore, background noise introduces data correlation inconsistency, the approach therefore also suppresses the background noise and improves CNR.

Since the correlation consistency operator is calculated with the corrupted data, it is amenable to use with iterative reconstruction to further reduce artifacts. Two parameters can be modified/updated during iteration. First, the calibration signal can be updated after each iteration. In the first iteration, the convolution kernel is calculated using the motion corrupted data. Therefore, convolution kernel with the updated calibration signal, which contains less motion artifacts, potentially can further reduce motion artifacts. Second, in each iteration, the convolution kernel support can be modified. In this way, reconstructions with various residual motion artifacts can be produced. The average of these reconstructions contains less residual motion artifacts than each individual reconstruction. The method proposed in Fautz et al., “Artifact Reduction in Moving-Table Acquisitions Using Parallel Imaging and Multiple Averages”, Magn. Reson. Med. vol. 57 pages 226-32, 2007 is a specific implementation of the proposed method using iterative scheme with modified kernels in each iteration. Unlike the approach of Fautz et al., in the motion compensation performed by the kernel convolution module 60 as disclosed herein only one set of new k-space data is produced and the original k-space data is not used in final reconstruction. Based on these ideas, experiments were performed with the previously-described data sets. The results demonstrated that it was true that the image quality can be further improved after iterations. However, the improvement is insignificant. Considering the longer reconstruction time, iteration is suggested only when reconstruction time is not crucial.

This application has described one or more preferred embodiments. Modifications and alterations may occur to others upon reading and understanding the preceding detailed description. It is intended that the application be construed as including all such modifications and alterations insofar as they come within the scope of the appended claims or the equivalents thereof.

1. A method comprising:
detecting subject rotation in a magnetic resonance (MR) imaging data set; and
reconstructing the MR imaging data set compensating for the detected subject rotation to generate a reconstructed subject image.

2. The method as set forth in claim 1, wherein the detecting comprises:
acquiring reference k-space data;
acquiring region k-space data together with the MR imaging data set, the region k-space data spanning a two-dimensional k-space region that encompasses the reference k-space data in the absence of subject motion; and
correlating the reference k-space data and the region k-space data to detect subject positional information including at least subject rotation.

3. The method as set forth in claim 2, wherein the reference k-space data is a reference k-space line.

4. The method as set forth in claim 3, wherein the correlating further detects subject positional information including subject translation along the direction of the k-space line.

5. The method as set forth in claim 4, wherein the correlating further detects subject positional information including subject translation transverse to the direction of the k-space line based on a phase relationship of the correlated reference k-space data and region k-space data.

6. The method as set forth in claim 2, wherein the MR imaging data set is two-dimensional and the correlating further detects subject positional information including through-plane subject positional information based on strength of correlation between the reference k-space data and region k-space data.

7. The method as set forth in claim 1, wherein the MR imaging data set is a partially parallel imaging (PPI) MR imaging data set acquired using a plurality of independent MR signal acquisition channels.

8. The method as set forth in claim 7, wherein the reconstructing comprises:
reconstructing the MR imaging data set using a GRAPPA operator to extrapolate k-space data missing due to the detected subject rotation.

9. The method as set forth in claim 7, wherein the reconstructing comprises:
reconstructing the MR imaging data set using high-pass GRAPPA to compensate for through-plane subject motion.

10. The method as set forth in claim 1, wherein the reconstructing further comprises:
compensating for subject motion based on at least one consistent correlation of k-space data of the MR imaging data set.

11. The method as set forth in claim 10, wherein the compensating comprises:
convolving the MR imaging data set with a kernel embodying the at least one consistent correlation of k-space data of the MR imaging data set.

12. The method as set forth in claim 11, wherein the kernel embodies consistent correlation of k-space data of the MR imaging data set including one or more of:
a consistent conjugate symmetric k-space correlation,
a consistent correlation of spatially neighboring k-space data, and
a consistent correlation of k-space data acquired using different MR signal acquisition channels.

13. The method as set forth in claim 11, wherein the kernel comprises a linear combination of correlated k-space data.

14. A method comprising:
compensating an MR imaging data set for subject motion based on at least one consistent correlation of k-space data of the MR imaging data set; and
reconstructing the MR imaging data set to generate a reconstructed subject image.

15. The method as set forth in claim 14, wherein the compensating comprises:
convolving the MR imaging data set with a kernel embodying the at least one consistent correlation of k-space data of the MR imaging data set.

16. The method as set forth in claim 15, wherein the kernel embodies consistent correlation of k-space data of the MR imaging data set including one or more of:
a consistent conjugate symmetric k-space correlation,
a consistent correlation of spatially neighboring k-space data, and
a consistent correlation of k-space data acquired using different MR signal acquisition channels wherein the MR imaging data set is a partially parallel imaging (PPI) MR imaging data set acquired using a plurality of independent MR signal acquisition channels.

17. The method as set forth in claim 15, wherein the kernel comprises a linear combination of correlated k-space data.

18. The method as set forth in claim 17, wherein the linear combination of correlated k-space data extends in either one direction or in two different non-parallel directions.

19. A magnetic resonance imaging system comprising:
a magnetic resonance scanner; and
an image reconstruction module configured to reconstruct an MR imaging data set acquired by the MR scanner using a method as set forth in claim 1.

20. A processor configured to reconstruct a magnetic resonance imaging data set using a method as set forth in claim 1.

21. A digital storage medium storing instructions executable by a digital processor to reconstruct a magnetic resonance (MR) imaging data set using a method as set forth in claim 1.
